(19) United States
(12) Patent Application Publication
(10) Pub. No.: US 2026/0145283 A1
(43) Pub. Date: May 28, 2026

(54) Modular Two-Operation Automation System for CNC Machining Utilizing Integrated Pneumatic Vises and Automated Part-Flipping Station

(71) Applicant: Michael Gimbel, Alhambra, CA (US)

(72) Inventor: Michael Gimbel, Alhambra, CA (US)

(21) Appl. No.: 19/401,195

(22) Filed: Nov. 25, 2025

Related U.S. Application Data
(60) Provisional application No. 63/726,313, filed on Nov. 28, 2024.

(51) Int. Cl. B23Q 3/08; B23Q 3/18; B23Q 15/22

(52) U.S. Cl. CPC B23Q 3/08; B23Q 3/18; B23Q 15/22; B23Q 2701/02; B23Q 2703/04

(57) ABSTRACT

An automation module for CNC machining is disclosed, enabling fully automated two-operation part processing on a three-axis milling machine. The system comprises a manifold base integrating a first pneumatic vise, a second pneumatic vise, and a part-flipping station disposed therebetween. The vises secure a workpiece for sequential machining operations, while the part-flipping station reorients the workpiece between operations. All pneumatic actuation is internally routed through the base and controlled via solenoids, facilitating rapid setup and modular installation. The system supports robotic or pneumatic part-handling devices and includes a standardized 96 mm pull-stud pattern for compatibility with zero-point fixturing systems. Macro-based software templates allow for streamlined CNC programming across multiple controller platforms. The invention reduces setup time, eliminates manual repositioning, and enables continuous, unattended machining of dual-operation components.

### BACKGROUND OF THE INVENTION

### Field of Invention

The present invention relates generally to the field of computer numerical control (CNC) machining and, more specifically, to automated machine-tending systems for multi-operation part processing. More particularly, the invention pertains to a modular automation element that integrates pneumatic vises and a part-flipping station onto a unified manifold base, facilitating the complete machining of two-operation components within a single cycle on a three-axis CNC milling machine.

### BRIEF SUMMARY OF THE INVENTION

The present invention provides a modular automation system for fully automating the machining of two-operation components on a three-axis CNC machine. The system comprises an integrated manifold baseplate equipped with a first pneumatic vise (Op1 Vise), a second pneumatic vise (Op2 Vise), and an intermediate, pneumatic part-flipping station. In use, a workpiece is first secured in the Op1 Vise for initial machining, then automatically transferred by a robotic or pneumatic gripper to the flipping station, where it is reoriented and moved to the Op2 Vise for second-operation machining. All components are pneumatically actuated via solenoid-controlled air lines routed internally through the base, allowing for rapid installation and clean integration. The system includes an industry standard 96 mm pull-stud pattern for compatibility with zero-point fixturing systems and supports macro-based programming templates for various CNC controllers, enabling streamlined implementation for both novice and experienced users.

### BRIEF DESCRIPTION OF THE FIGURES

FIG. 1 is an isometric view of the Two-Operation Automation Module illustrating the integrated configuration of dual pneumatic vises and a part-flipping station;

FIG. 2 is a detailed view of the Automation Module Baseplate, illustrating the internal pneumatic routing of the unified manifold baseplate;

FIG. 3 is an isometric view of the Two-Operation Automation Module interfacing with a zero-point chuck system;

FIG. 4 is a top down view of the Two-Operation Automation Module

FIG. 5 is a flowchart depicting the steps for Two-Operation part processing using the Two-Operation Automation Module.

### DETAILED DESCRIPTION

The present invention relates to a modular automation system designed for the complete machining of two-operation workpieces on a three-axis CNC milling machine. The invention comprises a unified automation module configured to receive, orient, and process individual parts through two discrete machining operations without manual intervention.

In one embodiment, the automation module includes an integrated manifold base upon which three primary components are mounted: a first pneumatic self-centering vise (hereinafter referred to as the “Op1 Vise”), a second pneumatic self-centering vise (“Op2 Vise”), and an automated part-flipping station (“Flip Station”) interposed therebetween. Each vise is pneumatically actuated and capable of applying adjustable clamping forces. The manifold base is designed such that it can accommodate various sizes and orientation of pneumatic vises, depending on user or application-specific requirements.

Specific workholding requirements can be easily accommodated by means of replaceable vice jaw blocks. These jaws allow for fast and repeatable changeover between different components being automated, and allow for machining to exact specifications for first or second operation workholding to be met.

In some embodiments, the automation module might be outfitted with different pneumatically actuated workholding devices, such as a collet closer or three jaw chuck. In this arrangement, the module can be optimized for running workpieces starting from a round shape. The arrangement of two work holding devices with an automated part-flipping station interposed therebetween is unchanged.

The manifold baseplate is constructed with internal air routing, allowing all pneumatic actuation lines to be concealed within the structure of the base, and providing a single, consistent location for connection of pneumatic lines. In a preferred embodiment, seven discrete air connections are routed through the front face of the module, and the entire system is controlled by a set of solenoid valves. This configuration enables rapid installation and minimizes external pneumatic clutter, making the system ideally suited for environments requiring frequent pallet changes or modular fixture swapping and improving cleanliness by removing potential obstructions.

The Flip Station comprises a pair of automated fingers or actuators configured to receive a partially machined workpiece from the Op 1 Vise, reorient it by 180 degrees along a defined flipping axis, and present it in a manner suitable for precise placement into the Op2 Vise. This process is executed either by a robotic arm, pneumatic gripper (e.g., GimGripper™), or vacuum-based gripping device (e.g., GimVac™), depending on the machine tending configuration adopted by the end user. These devices can be mounted to a robotic arm, to the CNC spindle, or to a gantry-based system depending on the automation environment. The Flip Station fingers and finger interface allow for rapid and repeatable adjustment to match process specifications.

The automation module is configured for direct integration with industry standard zero-point fixturing systems, most notably 5th Axis® Zero Point Systems, via a 96 mm pull-stud pattern pre-machined on the underside of the pallet. This allows the module to be installed and removed from the machine tool bed in under five minutes, significantly reducing machine downtime during setup or changeover. Furthermore, the repeatability of replacing the automation module onto the CNC machine is improved and simplified by use of the zero-point pull-studs. By use of the zero-point fixturing studs, the module can be removed and replaced without need of re-locating or re-aligning the module with respect to the CNC machine work coordinates.

The Automation Module is further configured for generic mounting to the worktable of a CNC machine by use of machined grooves for clamping by use of toe clamps or other such hold down clamps. This provides for a flexible mounting option available for any CNC machine with a T-slotted work table.

In a preferred embodiment, the automation module enables part-loading based automation solely using the software and hardware controls available from the CNC machine tool that it is installed onto. External solenoids may be added to the CNC machine, based on existing configuration. The CNC controller provides the commands to transfer the workpiece to and from each station of the module, and to toggle the state of any of the stations.

To facilitate ease of implementation, the invention includes a set of macro-based programming templates compatible with popular CNC controller platforms such as Haas, Brother, Fanuc, and DN Solutions. These templates abstract the complexity of two-operation part programming by enabling users to call machining subroutines using standard G-code commands (e.g., G65), requiring minimal changes to existing part programs aside from the replacement of the conventional end-of-program command (M30) with a loop instruction (M99). For users unfamiliar with macro programming, the system may be deployed through Turnkey or Semi-Turnkey Services offered by the provider, ensuring successful integration without user-side customization.

In one preferred use case, a raw part blank is automatically loaded into the Op1 Vise via a robotic gripper. The first machining operation is then performed according to the programmed routine. Upon completion, the robotic system removes the part from the Op1 Vise, engages the Flip Station to reorient the part, and places it into the Op2 Vise. The second machining operation is performed, after which the finished part is ejected or removed, and the cycle begins anew with the next blank. The entire process is continuous and cyclical, optimized for high-mix, low-volume or high-volume manufacturing environments.

The invention addresses longstanding challenges in the automation of dual-operation part processing on vertical CNC machines, particularly in relation to part repositioning, setup complexity, and system repeatability. By unifying clamping, flipping, and air management into a single module, and providing programmable control via standard CNC interfaces, the invention greatly reduces the barriers to entry for automated machining and enhances productivity across a range of manufacturing sectors.

### DETAILED DESCRIPTION OF FIGURES

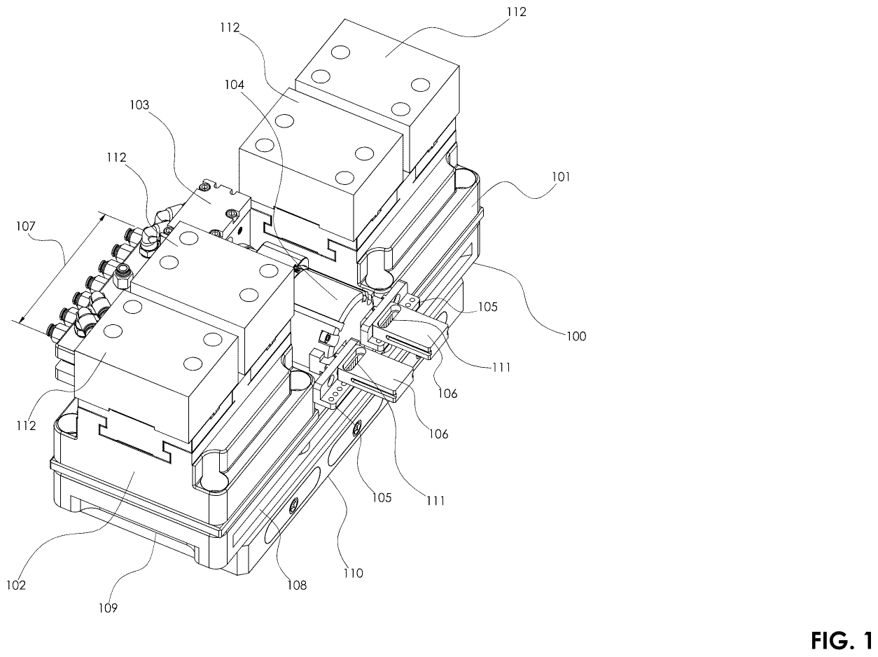

FIG. 1 illustrates an isometric view of the Two-Operation Automation Module according to the present invention. The module comprises a rigid manifold baseplate upon which two pneumatic vises are mounted on opposing ends, with a centrally located part flipping station.

OP1 Vise 101 mounts to the far end of manifold baseplate 100 and OP2 vise 102 mounts to the close end. The part flipping station consists of the rotating actuator 103, finger gripper 104, finger adapters 105 and gripper fingers 106, located centrally between OP1 Vise 101 and OP2 Vise 102, mounted on manifold baseplate 100. Single location pneumatic control line hookup 107 allows for clean and easy connection to the automation module when removing and replacing in the CNC machine environment. The automation module is optionally mounted on zero-point chuck system 110 for further improvements to speed and repeatability when removing and replacing the module in the CNC machine environment. Hand-holds 109 are integral to the baseplate for easy handling. Slots 108 are made available for alternative mounting options within the CNC environment. Adaption to specific workpiece size and specifications are made possible by removable and customizable vise jaw blocks 112. Flip Station gripper fingers can be adjusted to using slots 111 within fingers 106 along with holes in finger adapters 105. With the various adjustments and ergonomic improvements made to the automation module, CNC operators and setup personnel can make use of the module quickly, easily and for a variety of work.

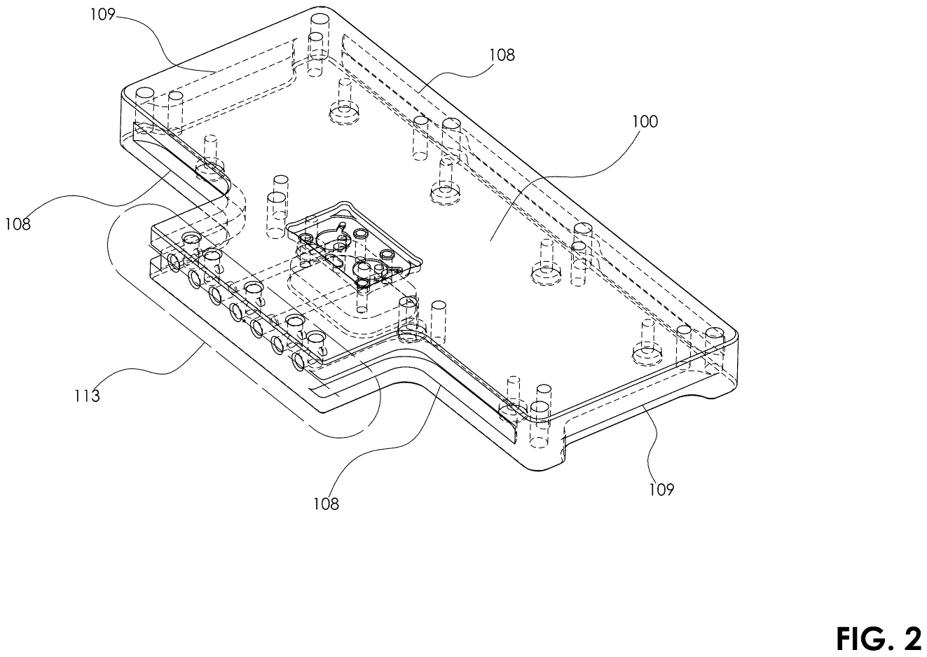

FIG. 2 depicts a detailed view of the automation module manifold baseplate. The baseplate is the component in which most of the ergonomics and adjustments are accommodated.

Baseplate 100 consists of a solid, single piece that houses the various components of the Two-Operation Automation Module. Three separate slots 108 are provided for flexible mounting in the CNC machine environment. Air Control Manifold 113 provides a single location hook-up point for the pneumatic control signals for the various functions of the automation module. Hand holds 109 provide a defined and ergonomic position to pickup the automation module to prevent damage to components or personnel.

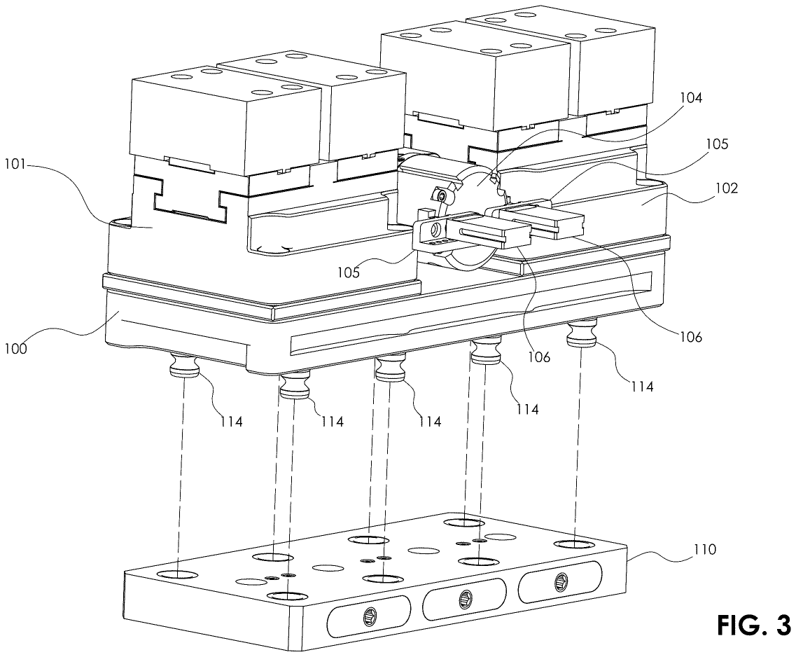

FIG. 3 shows an isometric view of the Two-Operation Automation Module and the interface with industry standard zero-point locating chucks.

The zero-point workholding studs 114 extend from the bottom of the manifold baseplate 100. These workholding studs interface with mating bushings in zero-point locating chuck 110. OP1 vise 101, OP2 vise 102 and part flip station (consisting of flip station gripper 104, finger adapters 105 and gripper fingers 106) mount to the top of the manifold baseplate 100. Rigid, repeatable location of all components on the manifold baseplate is achieved by use of the zero-point locating chuck interface. Quick and repeatable location of the Two-Operation Automation Module allows for rapid workholding changeover and minimizes downtime for the CNC machine.

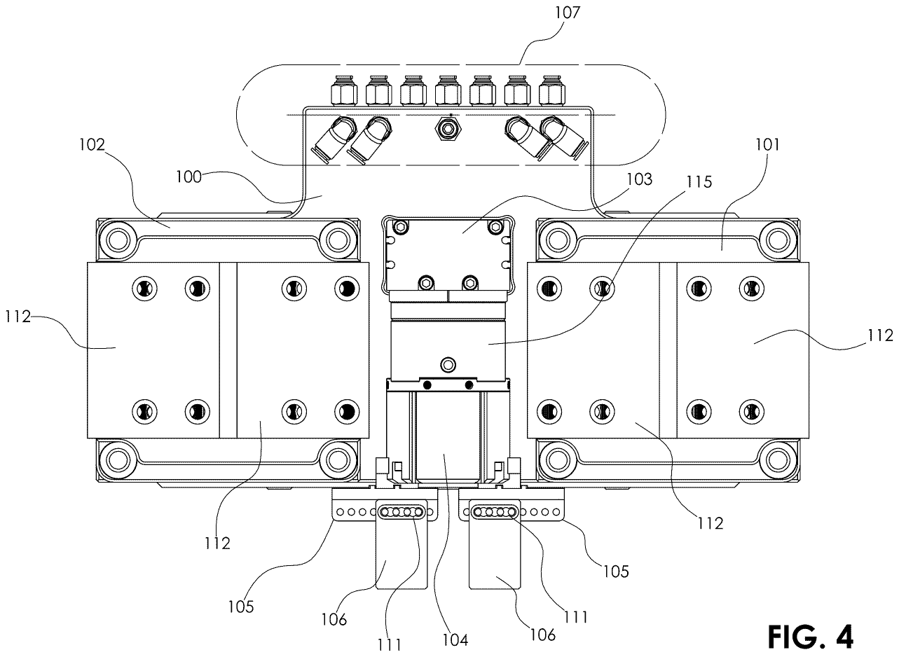

FIG. 4 shows a top-down view of the Two-Operation Automation Module, and the layout of the various components.

OP1 Vise 101 and OP2 Vise 102 are on opposing ends of manifold baseplate 100. Replaceable vise jaws 112 are on both OP1 vise and OP2 vise. The Part Flip Station is interposed between the OP1 vise and OP2 vise, and consists of rotary actuator 103, gripper adapter 115, flip station gripper 104, finger adapters 105 and gripper fingers 106. Gripper fingers 106 may be adjusted using slots 111 and threaded holes in 105 to process specifications required. Rotary actuator 103 can be engaged to rotate in a range of 0 to 190 degrees, with setscrew adjustment to facilitate the flipping operation. Gripper adapter 115 provides a clean, smooth interface for the pneumatic control signal to pass through the rotary actuator and into the flip station gripper 104. Single point control pneumatic control interface 107 provides connection points and access to the internal manifold baseplate. This single location interface allows for fast, accurate and efficient installation and removal of the automation module.

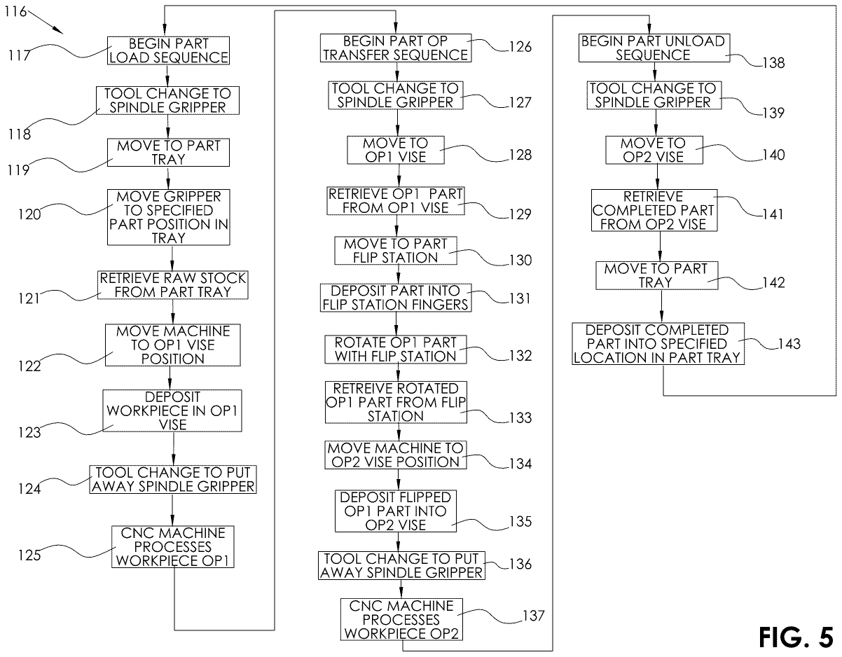

FIG. 5 is a flowchart illustrating the process of using the Two-Operation Automation Module.

Flow chart 116 consists of the following: The part loading sequence 117 begins when the CNC control program calls for the beginning of the cycle. The CNC machine will then perform a tool change to the spindle gripper 118. The machine motion then is used to move the spindle gripper to the part tray 119, and then the machine program instructs the movement to the specific part position to be processed 120. The spindle gripper retrieval sequence is carried out to pick the raw stock from the part tray 121. With the raw stock in the spindle gripper, the machine motion is used to move to the OP1 vise position 122. The spindle gripper drop-off process is used to deposit the workpiece into the OP1 vise 123. The CNC machine again carries out a tool change to put away the spindle gripper 124. The CNC program can now process the workpiece for the first operation 125. Once the workpiece is processed through the first operation, the OP transfer sequence 126 can begin. The CNC machine is again commanded to change tools to the spindle gripper 127 and then move to the OP1 vise position 128. The spindle gripper is used to retrieve the OP1 part from the OP1 vise 129, and then move to the part flip station 130. The spindle gripper deposits the OP1 part into the flip station fingers 131 and then the flip station is actuated to rotate the OP1 part 132. The spindle gripper is again employed to retrieve the rotated OP1 part from the flip station 133 and then can move the rotated OP1 part to the OP2 vise position 134. The rotated OP1 part is deposited into the OP2 vise 135 and the spindle gripper is put away 136. The CNC machine can now start processing OP2 137. Once completed, the part unload sequence 138 begins. The CNC machine performs a tool change to the spindle gripper 139 and then moves to the OP2 vise position 140. The spindle gripper retrieves the finished OP2 part 141 and moves to the part tray position 142 where it was originally picked from. The finished component is deposited into the part tray 143. The entire process can now loop indefinitely, as long as there are raw parts loaded into the part tray, or until an operator calls a stop to the cycle.

What is claimed is:

1. An automation module for use with a computer numerical control (CNC) machine, the module comprising:
(a) a manifold base having internal pneumatic air routing;
(b) a first pneumatic vise mounted on the manifold base and configured to receive a workpiece for a first machining operation;
(c) a second pneumatic vise mounted on the manifold base and configured to receive the workpiece for a second machining operation;
(d) a part-flipping station disposed between the first and second pneumatic vises, the part-flipping station configured to reorient the workpiece between operations; and
(e) a plurality of pneumatic solenoid connections coupled to the manifold base for actuating the first vise, the second vise, and the part-flipping station, wherein the module is configured for automated machining of a two-operation part on a three-axis CNC machine without manual repositioning of the workpiece.

2. The automation module of claim 1, wherein the first and second pneumatic vises are self-centering vises.

3. The automation module of claim 1, wherein the part-flipping station comprises a pair of actuated fingers configured to grip and rotate the workpiece 180 degrees about a flipping axis.

4. The automation module of claim 1, wherein the manifold base comprises a pre-machined 96mm pull-stud pattern configured for compatibility with a zero-point fixturing system.

5. The automation module of claim 1, wherein the internal pneumatic air routing is configured to interface with at least four two-way solenoids through seven air line connections.

6. The automation module of claim 1, wherein the first and second pneumatic vises are selected from a group consisting of 75 mm vises and 100 mm vises.

7. The automation module of claim 1, further comprising macro-based software templates configured for integration with CNC machine controllers selected from the group consisting of Haas, Brother, Fanuc, and DN Solutions.

8. The automation module of claim 1, further comprising at least one robotic or pneumatic part-handling device selected from the group consisting of:
(a) a spindle-mounted gripper;
(b) a vacuum-based grabber; and
(c) a robotic arm gripper, configured to transfer the workpiece between the first vise, the part-flipping station, and the second vise.

9. The automation module of claim 1, wherein the first and second pneumatic vises each provide clamping force that is adjustable.

10. A method of automating the machining of a two-operation workpiece on a CNC machine using the automation module of claim 1, the method comprising the steps of:
(a) positioning a raw workpiece into the first pneumatic vise;
(b) performing a first machining operation on the workpiece;
(c) transferring the workpiece from the first pneumatic vise to the part-flipping station;
(d) reorienting the workpiece using the part-flipping station;
(e) transferring the reoriented workpiece to the second pneumatic vise; and
(f) performing a second machining operation on the workpiece.
